(19) United States
(12) Patent Application Publication
(10) Pub. No.: US 2026/0129221 A1
(43) Pub. Date: May 7, 2026

(54) FRAME ALLOCATION OPTIMIZATION

(71) Applicant: QUALCOMM Incorporated, San Diego, CA (US)

(72) Inventor: Shengqi YANG, Carlsbad, CA (US)

(21) Appl. No.: 18/938,203

(22) Filed: Nov. 5, 2024

(51) Int. Cl. H04N 19/426; G06T 1/60; H04N 19/105; H04N 19/156; H04N 19/172

(52) U.S. Cl. CPC H04N 19/426; G06T 1/60; H04N 19/105; H04N 19/156; H04N 19/172

(57) ABSTRACT

This disclosure provides systems, devices, apparatus, and methods, including computer programs encoded on storage media, for optimizing storage space used for processing frames, for example encoding frames or decoding frames. A display processor may obtain an indication of a set of frames for processing. The display processor may identify a subset of the set of frames as a set of reference frames. The display processor may determine a set of reference timing windows (RTW) for a reference frame of the identified set of reference frames. The display processor may deallocate a set of memory addresses associated with the reference frame based on the determined set of RTW.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address overutilization of rapid memory while processing frames, for example while encoding or decoding frames. There is a need for frame buffer maintenance techniques.

### BRIEF SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory and, based at least in part on information stored in the memory, the at least one processor may be configured to obtain an indication of a set of frames for processing. For example, the at least one processor may encode the set of frames or may decode the set of frames. The at least one processor may identify a subset of the set of frames as a set of reference frames. The at least one processor may determine a set of reference timing windows (RTW) for a reference frame of the identified set of reference frames. The at least one processor may deallocate a set of memory addresses associated with the reference frame based on the determined set of RTW.

In some aspects, the techniques described herein relate to a method of display processing, including: obtaining an indication of a set of frames for processing; identifying a subset of the set of frames as a set of reference frames; determining a set of reference timing windows (RTW) for a reference frame of the identified set of reference frames; and deallocating a set of memory addresses associated with the reference frame based on the determined set of RTW.

In some aspects, the techniques described herein relate to a method, further including: processing the set of frames in response to the obtained indication of the set of frames for processing, where processing the set of frames includes encoding the set of frames; and outputting an indication of the encoded set of frames.

In some aspects, the techniques described herein relate to a method, further including: processing the set of frames in response to the obtained indication of the set of frames for processing, where processing the set of frames includes decoding the set of frames; and outputting an indication of the decoded set of frames.

In some aspects, the techniques described herein relate to a method, further including: storing the reference frame in the set of memory addresses based on the determined set of RTW.

In some aspects, the techniques described herein relate to a method, further including: encoding a subset of the set of frames during a last time window of the determined set of RTW, where deallocating the set of memory addresses associated with the reference frame based on the determined set of RTW includes: deallocating the set of memory addresses after the last time window of the determined set of RTW.

In some aspects, the techniques described herein relate to a method, further including: refraining from allocating a second set of memory addresses to a second subset of the set of frames based on an identification of the second subset of the set of frames as a set of unreferenced frames.

In some aspects, the techniques described herein relate to a method, where determining the set of RTW for each reference frame of the identified set of reference frames includes: determining a first set of contiguous RTW and a second set of contiguous RTW associated with the reference frame, where the second set of contiguous RTW is after the first set of contiguous RTW, where a time gap exists between the first set of contiguous RTW and the second set of contiguous RTW, where the set of memory addresses are associated with a first memory storage device, further including: processing a subset of the set of frames during the first set of contiguous RTW; and storing the reference frame in a second set of memory addresses associated with a second memory storage device different from the first memory storage device in response to the time gap being less than a threshold time period, where deallocating the set of memory addresses associated with the reference frame based on the determined set of RTW includes: deallocating the set of memory addresses after a last frame of the first set of contiguous RTW.

In some aspects, the techniques described herein relate to a method, where the first memory storage device includes double data rate (DDR) memory and the second memory storage device includes hard disk memory.

In some aspects, the techniques described herein relate to a method, further including: reading the reference frame from the second set of memory addresses associated with the second memory storage device; storing the reference frame in a third set of memory addresses associated with the first memory storage device based on the second set of contiguous RTW; processing a second subset of the set of frames during the second set of contiguous RTW; and deallocating the third set of memory addresses based on the second set of contiguous RTW.

In some aspects, the techniques described herein relate to a method, further including: deallocating the second set of memory addresses associated with the reference frame based on the determined set of RTW.

In some aspects, the techniques described herein relate to a method, further including: determining a first time period for storing the reference frame in the second set of memory addresses associated with the second memory storage device; determining a second time period for storing the reference frame in the third set of memory addresses associated with the first memory storage device; and determining the threshold time period as a sum of the first time period and the second time period.

In some aspects, the techniques described herein relate to a method, further including: decoding a second set of frames; and identifying a second subset of the second set of frames as a second set of reference frames, where determining the set of RTW for the reference frame of the identified set of reference frames includes: determining a second set of RTW for a second reference frame of the identified second set of reference frames; correlating the second reference frame of the identified second set of reference frames with the reference frame of the identified set of reference frames; and determining the set of RTW based on the correlated second reference frame and the determined second set of RTW.

In some aspects, the techniques described herein relate to a method, further including: deallocating a set of preallocated memory addresses associated with a third subset of the set of frames based on an identification of the third subset of the set of frames as a set of unreferenced frames.

In some aspects, the techniques described herein relate to a method, further including: decoding a second set of frames; identifying a second subset of the second set of frames as a second set of reference frames; decoding a third set of frames; and identifying a third subset of the third set of frames as a third set of reference frames, where determining the set of RTW for the reference frame of the identified set of reference frames includes: determining a second set of RTW for a second reference frame of the identified second set of reference frames; determining a third set of RTW for a third reference frame of the identified third set of reference frames; identifying a correlation between the second reference frame of the identified second set of reference frames and the reference frame of the identified set of reference frames or between the third reference frame of the identified third set of reference frames and the reference frame of the identified set of reference frames; and determining the set of RTW based on (a) the correlated second reference frame and the determined second set of RTW or (b) the correlated third reference frame and the determined third set of RTW.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system, in accordance with one or more techniques of this disclosure.

FIG. 2 illustrates an example display framework including a display processor and a display, in accordance with one or more techniques of this disclosure.

FIG. 3 illustrates an example source device and destination device, in accordance with one or more techniques of this disclosure.

FIG. 4 illustrates an example encoder and decoder, in accordance with one or more techniques of this disclosure.

FIG. 5 illustrates an example store-load architecture, in accordance with one or more techniques of this disclosure.

FIG. 6A illustrates an example infra-frame, predicted frame, predicted frame, bi-directional frame, bi-directional frame (IPPBB) group of pictures (GOP), in accordance with one or more techniques of this disclosure.

FIG. 6B illustrates an example table of reference timing windows (RTW) associated with the GOP of FIG. 6A, in accordance with one or more techniques of this disclosure.

FIG. 7A illustrates an example IPPBB group of pictures GOP, in accordance with one or more techniques of this disclosure.

FIG. 7B illustrates an example table of RTW associated with the GOP of FIG. 7A, in accordance with one or more techniques of this disclosure.

FIG. 8 is a call flow diagram illustrating example communications between a CPU and a GPU in accordance with one or more techniques of this disclosure.

FIG. 9 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a display processor (or display processor system) may obtain an indication of a set of frames for processing. As used herein, “processing” a set of frames may include encoding the set of frames or decoding the set of frames, for example using a codec such as advanced video coding (AVC) also known as H264, high efficiency video coding (HEVC) also known as (H265), or versatile video coding (VVC) also known as (H266). The display processor may identify a subset of the set of frames as a set of reference frames. A reference frame may be a frame that is used to encode, or decode, another frame in a set of frames. For example, a codec may describe an encoded frame as a difference between the reference frame (e.g., a background color with an object in a first location) and the encoded frame (e.g., the same background color and object, where the object is in a second location). The display processor may determine a set of reference timing windows (RTW) for a reference frame of the identified set of reference frames. A reference timing window may refer to a window of time during which a frame refers to the reference frame to encode the frame or to decode the frame. The display processor may deallocate a set of memory addresses associated with the reference frame based on the determined set of RTW. The set of memory addresses may be used to locate locations on a memory storage device (e.g., a rapid memory storage or a relatively slow memory storage) upon which a frame is stored. A rapid memory storage device may include, for example, double data rate (DDR) graphics memory (GMEM). A relatively slow memory storage device may include, for example, a hard disk drive (HDD) of a computer system.

In some aspects, a prediction-based load-store architecture may be implemented to save DDR usage while processing a video (e.g., encoding the video, decoding the video). A system may identify a reference frame and determine how long the reference frame is used (e.g., a set of RTW associated with the reference frame). In some aspects, the system may be configured to release the memory allocated/occupied by unused reference frame, as the system knows which RTW is correlated with processing that is associated with a reference frame, and processing that is not associated with the reference frame. The system may, for any concurrent session, release the memory occupied by a reference frame when the reference frame is not used anymore. The system may, for any concurrent session, release the memory occupied by a reference frame during an invalid time window, for example a reference frame that will no longer be used in a future RTW. The system may, for any concurrent session, release the memory occupied by a reference frame even at its valid time window if a session is put into the background, for example a reference frame that will be used in a future RTW but not during the current RTW. For a video encoding process, because a system may know the video group of pictures (GOP) structure before encoding starts, the system may know which frame is, and is not, a reference frame and may know how often each frame will be used for future frames. Thus, the system may disable reconstructed frame writes for frames that are not used for any future frame, and memory can be released/shared with other sessions when a predicted reference time window is finished. Additionally, for reference frames with multiple RTWs, the system may store the frame to a main memory (e.g., a hard disk memory) when the a first RTW finishes and then may retrieve the frame from cached memory (e.g., DDR memory) before the subsequent RTW. The system may take into consideration the time to load the frame from the main memory to the cached memory, unless the time to store and load is longer than the time gap between the RTWs. For a video decoding process, after a system decodes one frame, the system may not know if the frame is a reference frame or not. Moreover, the system may not know how often the frame will be used for decoding subsequent frames. However, the system may learn a GOP by decoding a few frames. Since GOPs may repeat, a first known GOP (learned through decoding a few frames) may be used to predict a subsequent unknown GOP. After a GOP is learned, the rules for encoding a set of frames with a known GOP may be used on the assumed predicted GOP on predicted reference pictures. The system may update such predictions when the system detects a new GOP sequence. Further, a ping-pong buffer can be used to keep the RTW for different GOPs (e.g., the system may ping-pong between a current GOP and a subsequent GOP).

Particular aspects of the subject matter described in this disclosure can be implemented to realize one or more of the following potential advantages. In some examples, by deallocating, or freeing, up memory that would normally be used to store unused reference frames, the described techniques can be used to minimize the amount of storage space used during encoding/decoding processes, decreasing the resources used for processing frames.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

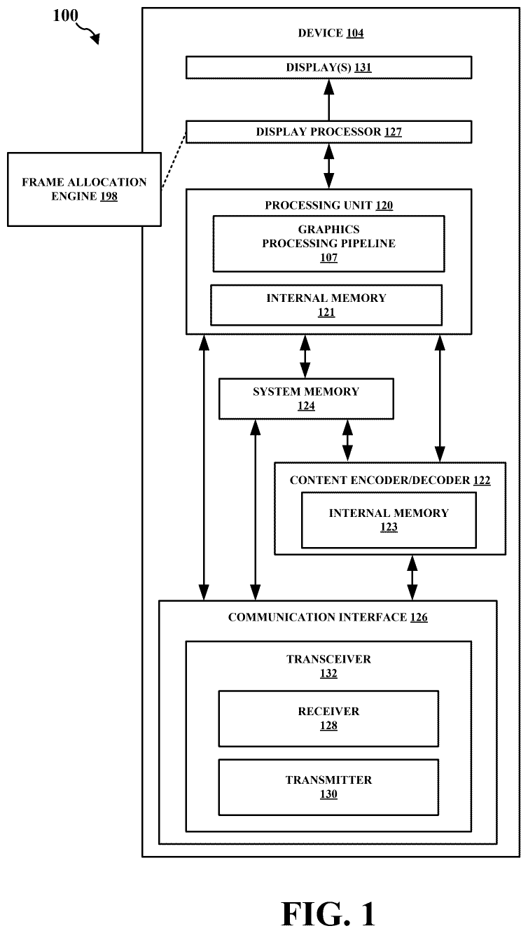

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a frame allocation engine 198 configured to obtain an indication of a set of frames for processing. The frame allocation engine 198 may be configured to identify a subset of the set of frames as a set of reference frames. The frame allocation engine 198 may be configured to determine a set of RTW for a reference frame of the identified set of reference frames. The frame allocation engine 198 may be configured to deallocate a set of memory addresses associated with the reference frame based on the determined set of RTW. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

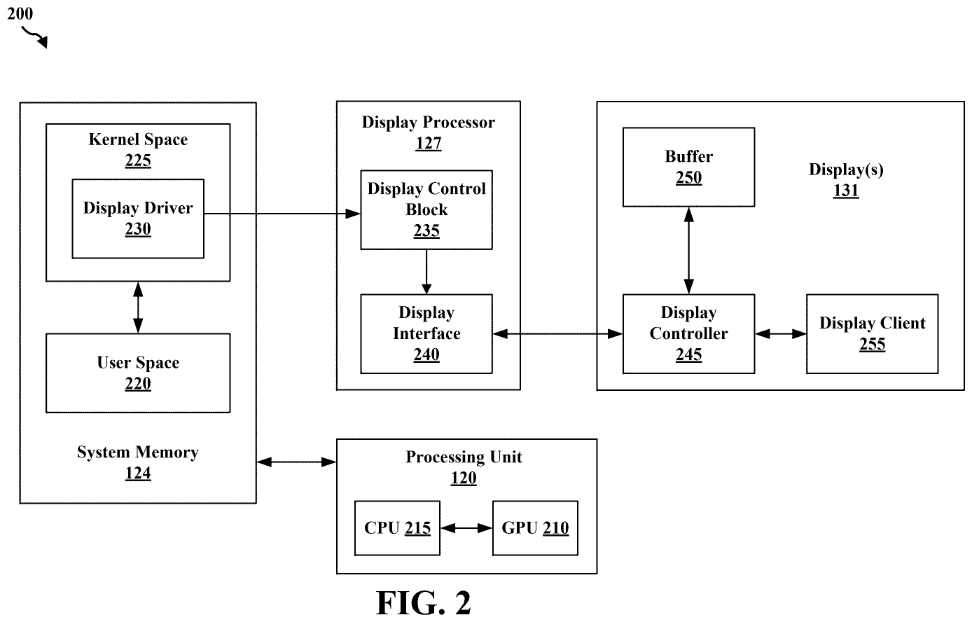

FIG. 2 is a block diagram 200 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 210 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 210 may be controlled based on one or more graphics processing commands provided by a CPU 215. The CPU 215 may be configured to execute multiple applications concurrently. In some cases, each of the concurrently executed multiple applications may utilize the GPU 210 simultaneously. Processing techniques may be performed via the processing unit 120 output a frame over physical or wireless communication channels.

The system memory 124, which may be executed by the processing unit 120, may include a user space 220 and a kernel space 225. The user space 220 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 225 may further include a display driver 230. The display driver 230 may be configured to control the display processor 127. For example, the display driver 230 may cause the display processor 127 to compose a frame and transmit the data for the frame to a display.

The display processor 127 includes a display control block 235 and a display interface 240. The display processor 127 may be configured to manipulate functions of the display(s) 131 (e.g., based on an input received from the display driver 230). The display control block 235 may be further configured to output image frames to the display(s) 131 via the display interface 240. In some examples, the display control block 235 may additionally or alternatively perform post-processing of image data provided based on execution of the system memory 124 by the processing unit 120.

The display interface 240 may be configured to cause the display(s) 131 to display image frames. The display interface 240 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 250.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 250. For example, when a Vsync pulse is generated, the display processor 127 may output new graphical content to the buffer 250. Thus, generation of the Vsync pulse may indicate that current graphical content has been rendered at the buffer 250.

Frames are displayed at the display(s) 131 based on a display controller 245, a display client 255, and the buffer 250. The display controller 245 may receive image data from the display interface 240 and store the received image data in the buffer 250. In some examples, the display controller 245 may output the image data stored in the buffer 250 to the display client 255. Thus, the buffer 250 may represent a local memory to the display(s) 131. In some examples, the display controller 245 may output the image data received from the display interface 240 directly to the display client 255.

The display client 255 may be associated with a touch panel that senses interactions between a user and the display(s) 131. As the user interacts with the display(s) 131, one or more sensors in the touch panel may output signals to the display controller 245 that indicate which of the one or more sensors have sensor activity, a duration of the sensor activity, an applied pressure to the one or more sensor, etc. The display controller 245 may use the sensor outputs to determine a manner in which the user has interacted with the display(s) 131. The display(s) 131 may be further associated with/include other devices, such as a camera, a microphone, and/or a speaker, that operate in connection with the display client 255.

Some processing techniques of the device 104 may be performed over three stages (e.g., stage 1: a rendering stage; stage 2: a composition stage; and stage 2: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 210 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

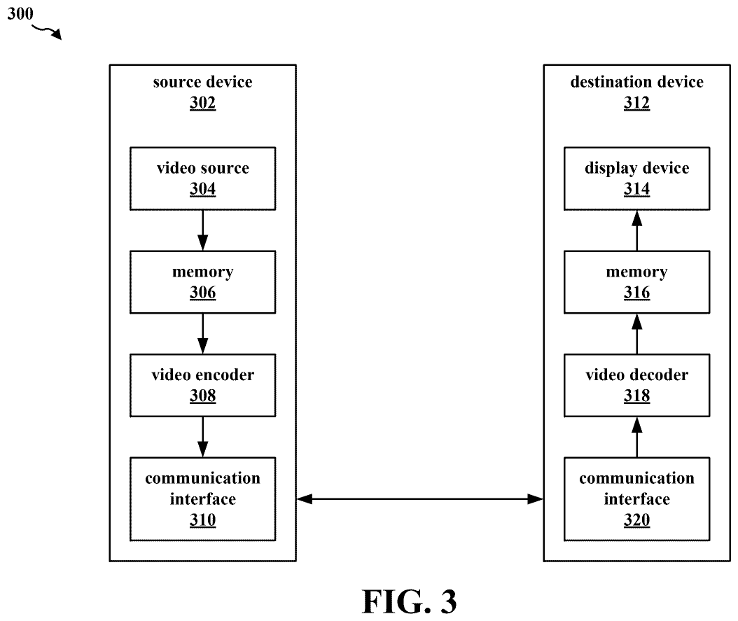

FIG. 3 is a diagram 300 of a source device 302 configured to encode a set of frames and a destination device 312 configured to decode a set of frames, respectively. The source device 302 may have a video source 304, for example a camera or a communication interface that receives a set of frames as an input stream. The video source 304 may have a memory 306 that stores the set of frames for a period of time for encoding. The memory 306 may be a transient or a non-transient memory that stores at least a portion of the set of frames, for example a subset of the set of frames, in a buffer to be read by the video encoder 308 for encoding. The video encoder 308 may encode the set of frames using a codec, for example H264, H265, or H266. The video encoder 308 may output at least a portion of the encoded frames to a communication interface 310, which may be a wired or a wireless interface, or may be a virtual interface between components of a software.

The communication interface 310 may output an encoded stream of frames to the destination device 312. The destination device 312 may receive the encoded stream of frames via the communication interface 320, which may be a wired or wireless interface, or may be a virtual interface between components of a software. The communication interface 320 may output at least a portion of the received encoded frames to the video decoder 318 for decoding the set of encoded frames using a codec, for example H264, H265, or H266. The video decoder 318 may output the set of decoded frames to a memory 316 for storage for a period of time. The memory 316 may be a transient or a non-transient memory that stores at least a portion of the set of decoded frames, for example a subset of the decoded set of frames, in a buffer to be output to the display device 314. The display device 314 may be, for example, a set of panels of a display for displaying decoded video content.

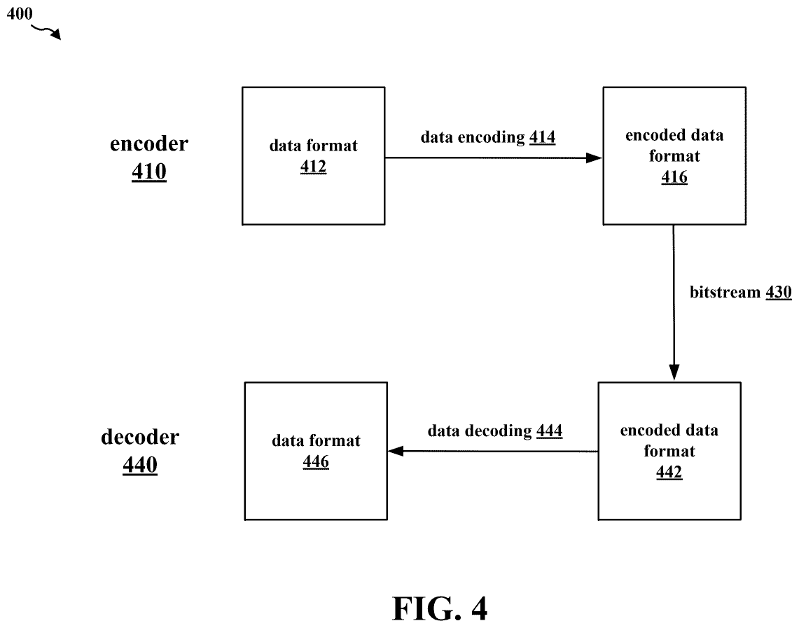

FIG. 4 is a diagram 400 illustrating an example data encoding and decoding process using an encoder 410 and a decoder 440. As shown in FIG. 4, diagram 400 includes encoder 410, data format 412, data encoding 414, encoded data format 416, bitstream 430, encoded data format 442, data decoding 444, data format 446, and decoder 440. FIG. 4 depicts that encoder 410 may perform data encoding 414 on data format 412, which may result in encoded data format 416. The encoder 410 may store the encoded data format 416 in the bitstream 430 and transmit the bitstream 430 to decoder 440. The decoder 440 may receive the bitstream 430 including the encoded data format 442. The decoder 440 may perform data decoding 444 on encoded data format 442, which may result in the data format 446 (i.e., a decoded data format). As such, FIG. 4 depicts that the encoder 410 may perform an encoding process (e.g., data encoding 414) and decoder 440 may perform a decoding process (e.g., data decoding 444) for data associated with data, graphics, and/or display processing.

In some aspects, a codec may use a maximum of sixteen reference frames to decode or encode a frame. Sixteen reference frames may use 50 megabytes (MB) of a memory footprint (e.g., in double-data rate (DDR) memory) for 1920 pixels by 1080-pixel (1080 p) resolution in 8-bit, 200 MB of a memory footprint for ultra-high definition (UHD) resolution in 8-bit, or 800 MB of a memory footprint for an eight-thousand-pixel UHD (8KUHD) resolution in 8-bit. If the video is 10-bit, the memory footprint may even double to 1700 MB for 8KUHD. A system may call the source device 302 or the destination device 312 multiple times for encoding and decoding multiple sessions, and multiple sessions may run concurrently. For example, a graphics chipset may support up to sixteen concurrent decoding sessions. In some aspects, for example multiple cameras recording an object from different angles, a graphics chipset may support multiple concurrent encoding sessions (e.g., 16 or 24 concurrent encoding sessions). If a graphics chipset is supporting 16 concurrent sessions of 1080 p resolution at 30 frames per second (fps), each session may use 100 MB of memory to encode, which may result in a total of 1.6 gigabytes (GB) of memory being used. For 16 sessions of UHD resolution at 30 fps, the graphics chipset may use 6.4 GB of memory to encode the sessions. As a result, improved memory sharing architecture may be useful to minimize the amount of memory being used in an encoding or decoding process.

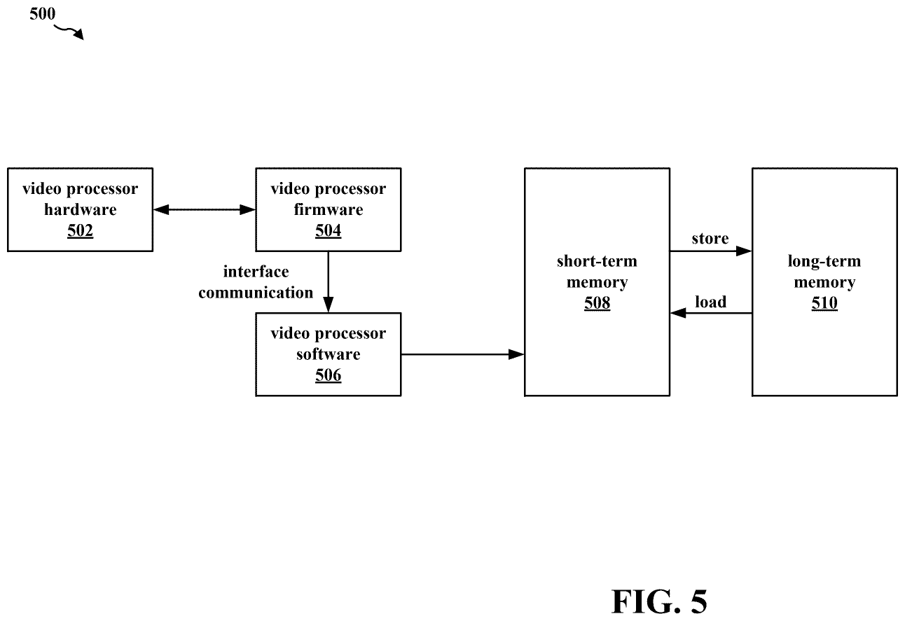

FIG. 5 is a diagram 500 of an architecture that may be used to support a prediction-based store-load model. The video processor hardware 502 may be any suitable hardware used to process a set of frames, for example a hardware that encodes or decodes a set of frames using a codec. In other words, the video processor hardware 502 may include video encoding/decoding hardware and a dedicated processor for processing encoding/decoding tasks. The video processor firmware 504 may be configured to interface with the video processor hardware 502 via a semi-persistent operating system that may be updated via a firmware update. The video processor firmware 504 may be configured to determine a GOP for at least a subset of the set of frames and may output an indication of the determination to the video processor software 506. In other words, the video processor firmware 504 may predict which frames of the set of frames are reference frames, which frames of the set of frames are not reference frames and sets of RTW associated with each of the reference frames that are used to encode/decode frames of the set of frames. In some aspects, the video processor firmware 504 may include a program executed on a processor of the video processor hardware 502, which may be used to program the registers of the video encoding/decoding hardware such that the video processor hardware 502 executes desired tasks (e.g., decoding a bitstream, encoding a video frame sequence). The video processor firmware 504 may output an indication of the prediction to the video processor software 506.

The video processor software 506 may include a device driver of the video processor hardware 502. The video processor software 506 may include software logic executed by a processor of the video processor hardware 502. An application running on a CPU may call the video processor software 506, which may then call the video processor firmware 504, which instructs the video processor hardware 502 to decode/encode a bitstream. The video processor software 506 may obtain the prediction information from the video processor firmware 504 and may use the prediction information to update an RTW table for each frame of a set of frames. In some aspects, the video processor hardware 502 may provide frame statistics (e.g., a GOP structure) to the video processor firmware 504, which has a communication interface with the video processor software 506 via a set of driver APIs. Frames that are not reference frames, also referred to as unreferenced frames, may have a null value associated with the frame.

The video processor software 506 may handle allocation and deallocation of memory on the short-term memory 508 and/or on the long-term memory 510. The short-term memory 508 may include a relatively rapid memory (as compared with the long-term memory 510), for example a double-data rate (DDR) graphics memory (GMEM). The long-term memory 510 may include a relatively slow memory (as compared with the short-term memory 508), for example a transient hard disk drive (HDD). The video processor software 506 may command a store-load command between the short-term memory 508 and the long-term memory 510. A store-load command may offload data from the short-term memory 508 to the long-term memory 510 or may load data from the long-term memory 510 to the short-term memory 508. The video processor software 506 may be configured to output a store-load command for any type of data that may be stored on the short-term memory 508 and the long-term memory 510, for example reference frames, GOP tables, or RTW information, during concurrent video processes, in order to conserve memory resources.

In some aspects, the largest component of memory during an encoding/decoding process is the space allocated for reference frames. Each session's reference frames may be held in memory to be used for a sessions next frame encoding process or decoding process. Since the memory occupied by the session's reference frames are not released if the next frame's encoding/decoding process will use those frames. Moreover, the memory is not sharable as other sessions do not use the reference frames from a particular session. A loss in a reference frame may result in a non-conforming video encoding/decoding process, so ensuring that no dependent reference frames are lost can be quite important. In some aspects, memory used by reference frames can be minimized by using a prediction-based load-store architecture, for example the architecture illustrated in FIG. 5. The video processor firmware 504 may perform the prediction and output the information to the video processor software 506. The video processor software 506 may update the RTW and command the store-load to the short-term memory 508 (e.g., the DDR) and/or the long-term memory 510 (e.g., a hard drive). Such architecture may be used to store/load any type of data, not just reference frames, during concurrent video processes to save memory used by a video process.

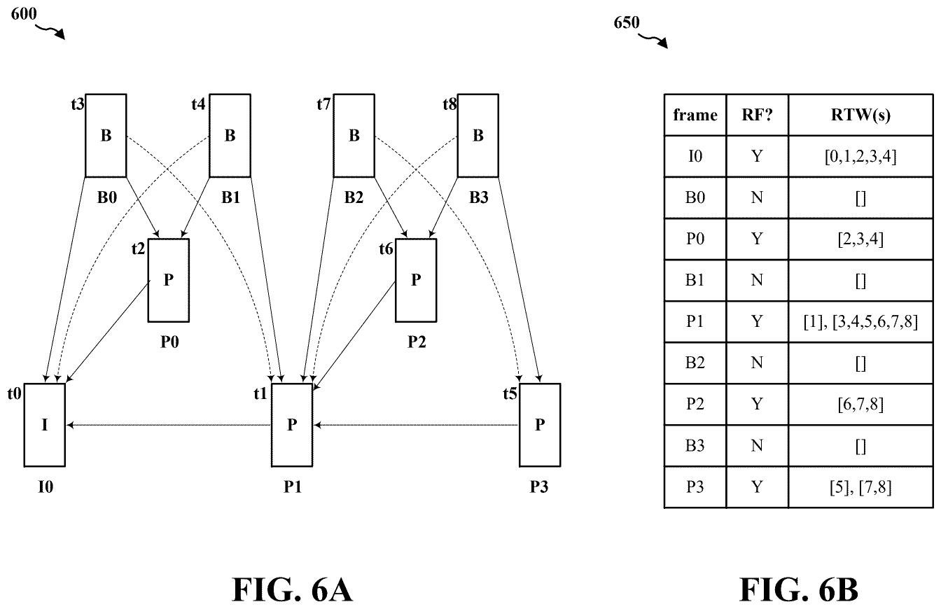

FIG. 6A is a diagram 600 of a GOP structure for a set of frames. The GOP structure may be an infra-frame, predicted frame, predicted frame, bi-directional frame, bi-directional frame (IPPBB) hierarchical structure for the set of frames. In some aspects, a system may generate the GOP structure before encoding based on a codec. In other words, the codec may include a technique for generating an optimized GOP structure of reference frames when encoding a set of frames. The GOP structure may indicate which frame is a reference frame and how many times each reference frame is used for other frames of the set of frames. The arrows in diagram 600 may refer to frame dependencies. While some of the arrows may be drawn using solid lines and dotted lines, the dotted lines are used to improve readability of the diagram 600 and should not be interpreted to be different from arrows using solid lines.

The diagram 600 shows an infra-frame I0, predicted frames P0, P1, P2, and P3, and bi-directional frames B0, B1, B2, and B3. The infra-frame I0 may be the first frame of a set of frames in a GOP. The predicted frames P0, P1, P2, and P3 may represent frames that are based on a previous frame, in chronological order, for a video having the set of frames. The bi-directional frames B0, B1, B2, and B3 may represent frames that may be based on at least one previous frame and at least one subsequent frame, in chronological order, for a video having the set of frames. The arrows illustrate encoding/decoding dependencies for each frame. As shown, frame 10 is a reference frame that is encoded at time t0 and is used to encode frame P1 at time t1, to encode frame P0 at time t2, to encode frame B0 at time t3, and to encode frame B1 at time t4. Frame P0 is a reference frame that is encoded at time t2 and is used to encode frame B0 at time t3, and to encode frame B1 at time t4. Frame P1 is a reference frame that is encoded at time t1 and is used to encode frame B0 at time t3, frame B1 at time t4, frame P3 at time t5, frame P2 at time t6, frame B2 at time t7, and frame B3 at time t8. Frame P2 is a reference frame encoded at time t6 and is used to encode frame B2 at time t7 and frame B3 and time t8. Frame P3 is a reference frame that is encoded at time t5 and is used to encode frame B2 at time t7 and frame B3 at time t8. Frames B0, B1, B2, and B3 are not reference frames, or may also be referred to as unreferenced frames.

FIG. 6B is a diagram 650 of a table that captures RTWs associated with each frame of the set of frames shown in the GOP of diagram 600 in FIG. 6A. As shown, frame I0 is a reference frame with a contiguous RTW [0, 1, 2, 3, 4], frame P0 is a reference frame with a contiguous RTW [2, 3, 4], frame P1 is a reference frame with an RTW [1] and a contiguous RTW [3, 4, 5, 6, 7, 8], frame P2 is a reference frame with an RTW [6, 7, 8], frame P3 is a reference frame with an RTW [5] and a contiguous RTW [7, 8], and frames B0, B1, B2, and B3 are unreferenced frames.

In some aspects, a frame allocation engine may be configured to completely disable reconstructed frame writes by the hardware for unreferenced frames, as the unreferenced frames are not used for any future frames. In other words, the frame allocation engine may disable reconstructed frame writes by the hardware for the frames B0, B1, B2, and B3 as there is no benefit for writing a reconstructed frame to memory. This may reduce the memory footprint for processing the set of frames shown in the GOP of in FIG. 6A.

In some aspects, a frame allocation engine may be configured to release a memory footprint occupied by a reference frame after its last RTW. For example, the frame allocation engine may be configured to release the memory footprint occupied by the reconstructed frame of the reference frame 10 after time t4, to release the memory footprint occupied by the reconstructed frame of the reference frame P0 after time t4, to release the memory footprint occupied by the reconstructed frame of the reference frame P1 after time t8, to release the memory footprint occupied by the reconstructed frame of the reference frame P2 after time t8, and to release the memory footprint occupied by the reconstructed frame of the reference frame P3 after time t8. After the frame allocation engine releases the memory footprint occupied by a reference frame, the memory previously occupied by the reference frame may be shared with other sessions. For example, at time t5, the memory occupied by the reconstructed frame of the reference frame 10 may be shared with other sessions, as no other frames use reference frame 10 after time t4.

In some aspects, a frame allocation engine may be configured to refrain from allocating a memory footprint to a reference frame until its first RTW. For example, the frame allocation engine may be configured to allocate the memory footprint occupied by a reconstructed frame of the reference frame 10 during, or shortly after time to (e.g., once the frame has been reconstructed), to allocate the memory footprint occupied by a reconstructed frame of the reference frame P1 during, or shortly after time t1, to allocate the memory footprint occupied by a reconstructed frame of the reference frame P0 during, or shortly after time t2, to allocate the memory footprint occupied by a reconstructed frame of the reference frame P3 during, or shortly after time t5, and to allocate the memory footprint occupied by a reconstructed frame of the reference frame P2 during, or shortly after time t6. Before the frame allocation engine allocates the memory footprint that will be occupied by a reference frame, the memory that will be occupied by the reference frame may be shared with other sessions. For example, at time t5, the memory that will be occupied by the reconstructed frame of the reference frame P2 may be shared with other sessions, as no other frames use reference frame P2 before time t6.

In some aspects, a frame allocation engine may be configured to determine whether a reference frame has split RTWs. For example, a reference frame may have a first RTW represented by [Tn, Tn+1, Tn+2, . . . Tn+i] and a second RTW represented by [Tn+i+k, Tn+i+k+1,Tn+i+k+2. . . Tn+i+k+m]. These split reference time windows may have a time gap between the reference time windows of the size k. For example, the reference frame P1 has a time gap of 2 RTWs between the first RTW [1] and the second RTW [3, 4, 5, 6, 7, 8]. The time gap between the two RTWs may be one time unit (i.e., one frame processing time). In another example, the reference frame P3 has a time gap of 2 RTWs between the first RTW [5] and the second RTW [7,8]. The time gap between the two RTWs may also be one time unit.

The frame allocation engine may define the time gap between two RTWs as G time units. So for the above example of a first RTW represented by [Tn, Tn+1, Tn+2, . . . Tn+i] and a second RTW represented by [Tn+i+k, Tn+i+k+1, Tn+i+k+2, . . . Tn+i+k+m], G=k. The frame allocation engine may also determine a time that may be spent on a STORE+LOAD function, where a STORE+LOAD function is the time it takes for the frame allocation engine to STORE a reconstructed frame saved to a short-term memory (e.g., DDR) on a long-term memory (e.g., an HDD), and then LOAD the reconstructed frame from the long-term memory back into the short-term memory. The determined time may be referred to as S/L. If S/L>G, the frame allocation engine may keep a reference frame in memory, as the gap is not long enough to accommodate the STORE+LOAD function. However, if S/L<G, the frame allocation engine may offload the reconstructed frame to the long-term memory, and release the short-term memory associated with the reconstructed frame to any concurrent session.

In other aspects, if a current session is set as a background process, then the frame allocation engine may offload all reference frames from the short-term memory to the long-term memory, and release the short-term memory associated with the reference frames to any other concurrent session. When the background session is revoked, the frame allocation engine may load the reference frames from the long-term memory to the short-term memory based on the RTWs associated with each reference frame. The frame allocation engine may load the first accessed frame into the short-term memory to reduce latency.

In some aspects, a frame allocation engine may obtain an indication of a GOP structure, such as the IPPBB hierarchical structure shown in FIG. 6A before encoding. The GOP structure may indicate which frames are reference frames, and how many times the reference frames are used for encoding subsequent frames. The frame allocation engine may predict, for each frame, an RTW, for example the set of RTWs shown in FIG. 6B. In some aspects, the frame allocation engine may completely disable the reconstructed frame write by the HW for any frames that are not used by subsequent frames (e.g., B1, B2, and B3. This reduces the memory footprint that would otherwise be used by storing such frames. In some aspects, the frame allocation engine may release the memory footprint occupied by a reference frame after its last RTW. For example, at time period 5, the frame allocation engine may release the memory footprint occupied by frame I0, and other sessions may use that memory footprint.

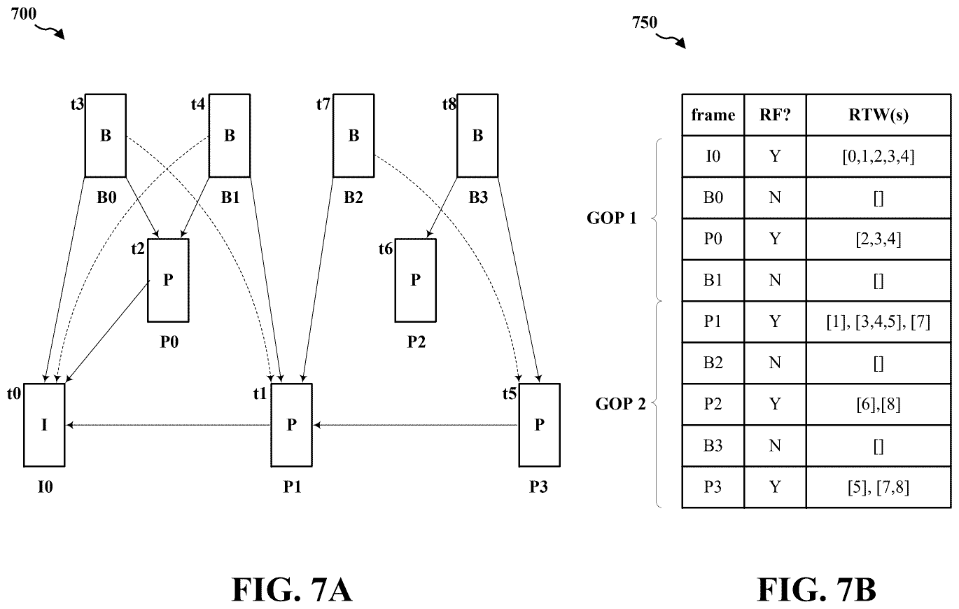

FIG. 7A is a diagram 700 of a GOP structure for a set of frames. The GOP structure may be an IPPBB hierarchical structure for the set of frames. In some aspects, a system may generate the GOP structure before encoding based on a codec. In other words, the codec may include a technique for generating an optimized GOP structure of reference frames when encoding a set of frames. The GOP structure may indicate which frame is a reference frame and how many times each reference frame is used for other frames of the set of frames. The arrows in diagram 700 may refer to frame dependencies. While some of the arrows may be drawn using solid lines and dotted lines, the dotted lines are used to improve readability of the diagram 700 and should not be interpreted to be different from arrows using solid lines.

The diagram 700 shows an infra-frame I0, predicted frames P0, P1, P2, and P3, and bi-directional frames B0, B1, B2, and B3. The infra-frame 10 may be the first frame of a set of frames in a GOP. The predicted frames P0, P1, P2, and P3 may represent frames that are based on a previous frame, in chronological order, for a video having the set of frames. The bi-directional frames B0, B1, B2, and B3 may represent frames that may be based on at least one previous frame and at least one subsequent frame, in chronological order, for a video having the set of frames. The arrows illustrate encoding/decoding dependencies for each frame. As shown, frame 10 is a reference frame that is encoded at time t0 and is used to encode frame B0 at time t1, to encode frame P0 at time t2, to encode frame B1 at time t3, and to encode frame P1 at time t4. Frame P0 is a reference frame that is encoded at time t2 and is used to encode frame B0 at time t1, and to encode frame B1 at time t3. Frame P1 is a reference frame that is encoded at time t4 and is used to encode frame B0 at time t1, frame B1 at time t3, frame B2 at time t5, frame P2 at time t6, frame B3 at time t7, and frame P3 at time t8. Frame P2 is a reference frame encoded at time t6 and is used to encode frame B2 at time t5 and frame B3 and time t7. Frame P3 is a reference frame that is encoded at time t8 and is used to encode frame B2 at time t5 and frame B3 at time t7. Frames B0, B1, B2, and B3 are not reference frames, or may also be referred to as unreferenced frames.

FIG. 7B is a diagram 750 of a table that captures RTWs associated with each frame of the set of frames shown in the GOP of diagram 700 in FIG. 7A. As shown, frame I0 is a reference frame with a contiguous RTW [0, 1, 2, 3, 4], frame P0 is a reference frame with a contiguous RTW [1, 2, 3], frame P1 is a reference frame with an RTW [1] and a contiguous RTW [3, 4, 5, 6, 7, 8], frame P2 is a reference frame with an RTW [5, 6, 7], frame P3 is a reference frame with an RTW [5] and a contiguous RTW [7, 8], and frames B0, B1, B2, and B3 are unreferenced frames.

In some aspects, a frame allocation engine may be configured to completely disable reconstructed frame writes by the hardware for unreferenced frames, as the unreferenced frames are not used for any future frames. In other words, the frame allocation engine may disable reconstructed frame writes by the hardware for the frames B0, B1, B2, and B3 as there is no benefit for writing a reconstructed frame to memory. This may reduce the memory footprint for processing the set of frames shown in the GOP of in FIG. 7A.

In some aspects, a frame allocation engine may be configured to release a memory footprint occupied by a reference frame after its last RTW. For example, the frame allocation engine may be configured to release the memory footprint occupied by the reference frame I0 after time t4, to release the memory footprint occupied by the reference frame P0 after time t3, to release the memory footprint occupied by the reference frame P1 after time t8, to release the memory footprint occupied by the reference frame P2 after time t7, and to release the memory footprint occupied by the reference frame P3 after time t8.

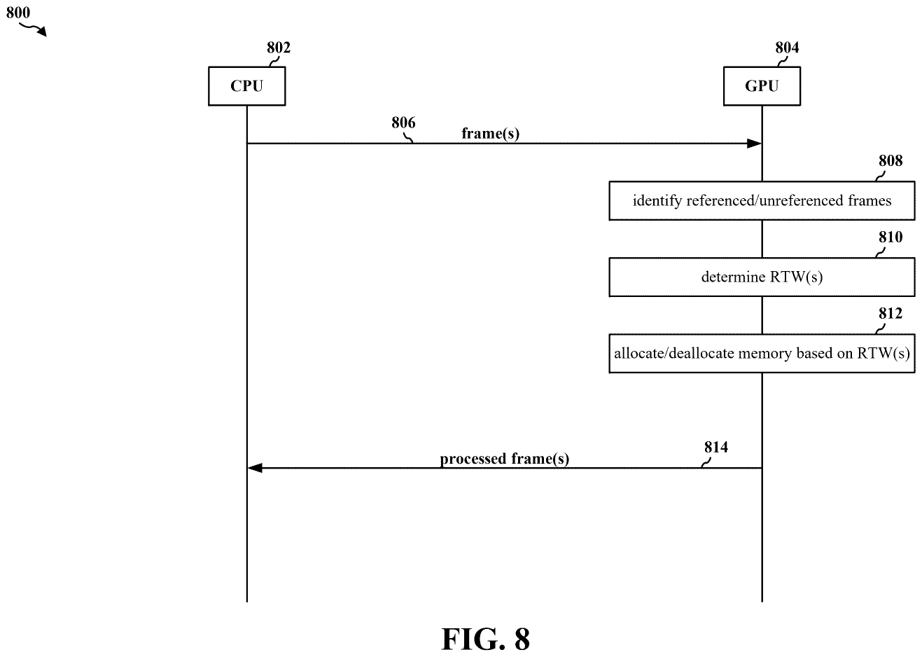

FIG. 8 is a call flow diagram 800 illustrating example communications between a CPU 802 and a GPU 804. The CPU 802 may output a set of frames 806 to the GPU 804. The GPU 804 may obtain the set of frames 806 from the CPU 802. The CPU 802 may output the set of frames 806 to the GPU 804 for the GPU 804 to process. The set of frames 806 may be a set of unencoded frames that may be transmitted to the GPU 804 for encoding by the GPU 804. The set of frames 806 may be a set of encoded frames that may be transmitted to the GPU 804 for decoding by the GPU 804.

At 808, the GPU 804 may identify the referenced and/or unreferenced frames of the set of frames 806 obtained from the CPU 802. For example, the GPU 804 may construct a GOP for the set of frames 806 before encoding the set of frames 806. In another example, the GPU 804 may construct a GOP for a first set of frames (e.g., a subset of the set of frames 806, or a set of frames previously obtained by the CPU 802), and may use that GOP as a template to predict the GOP for decoding a second set of frames (e.g., a second subset of the set of frames 806, or the set of frames 806). The GPU 804 may use the constructed GOP to identify which frames are reference frames, and which frames are unreferenced frames.

At 810, the GPU 804 may determine a set of RTWs associated with each frame of the set of frames 806. For example, unreferenced frames may not have any RTWs, or may have a null RTW. In other examples, the GPU 804 may determine a set of RTWs associated with each reference frame of the set of frames 806 and may not determine any RTWs associated with unreferenced frames. The GPU 804 may identify a gap in between RTWs and determine whether a store-load to a long-term memory device is appropriate between the RTWs.

At 812, the GPU 804 may allocate memory based on the RTWs. For example, the GPU 804 may refrain from allocating any memory to storing a reconstructed frame of an unreferenced frame. In another example, the GPU 804 may allocate memory to a reference frame at the beginning of the first RTW associated with the frame, and may deallocate memory at the end of the last RTW associated with the reference frame.

The GPU 804 may output an indication 814 of the set of processed frames to the CPU 802. The CPU 802 may obtain the indication 814 of the set of processed frames from the GPU 804. The set of processed frames may include a set of encoded frames. The set of processed frames may include a set of decoded frames.

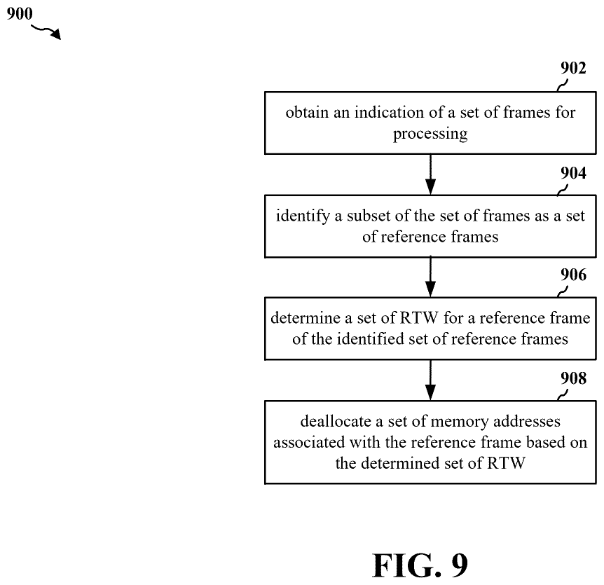

FIG. 9 is a flowchart 900 of an example method of display processing in accordance with one or more techniques of this disclosure. The method may be performed by an apparatus, such as an apparatus for display processing, a GPU, a CPU, a wireless communication device, and the like, as used in connection with the aspects of FIGS. 1-5, 6A-6B, 7A-7B, and 8.

At 902, the apparatus may obtain an indication of a set of frames for processing. For example, referring to FIG. 8, the GPU 804 may obtain an indication of a set of frames for processing.

At 904, the apparatus may identify a subset of the set of frames as a set of reference frames. For example, referring to FIG. 8, the GPU 804 may identify a subset of the set of frames as a set of reference frames.

At 906, the apparatus may determine a set of RTW for a reference frame of the identified set of reference frames. For example, referring to FIG. 8, the GPU 804 may determine a set of RTW for a reference frame of the identified set of reference frames.

At 908, the apparatus may deallocate a set of memory addresses associated with the reference frame based on the determined set of RTW. For example, referring to FIG. 8, the GPU 804 may deallocate a set of memory addresses associated with the reference frame based on the determined set of RTW.

In configurations, a method or an apparatus for display processing is provided. The apparatus may be a GPU, a CPU, or some other processor that may perform display processing. In aspects, the apparatus may be the processing unit 120 within the device 104, or may be some other hardware within the device 104 or another device. The apparatus may include means for obtaining an indication of a set of frames for processing. The apparatus may further include means for identifying a subset of the set of frames as a set of reference frames. The apparatus may further include means for determining a set of RTW for a reference frame of the identified set of reference frames. The apparatus may further include means for deallocating a set of memory addresses associated with the reference frame based on the determined set of RTW. The apparatus may further include means for processing the set of frames in response to the obtained indication of the set of frames for processing. Processing the set of frames may include encoding the set of frames; and outputting an indication of the encoded set of frames. The apparatus may further include means for processing the set of frames in response to the obtained indication of the set of frames for processing. Processing the set of frames comprises decoding the set of frames; and outputting an indication of the decoded set of frames. The apparatus may further include means for storing the reference frame in the set of memory addresses based on the determined set of RTW. The apparatus may further include means for encoding a subset of the set of frames during a last time window of the determined set of RTW. The apparatus may further include means for deallocating the set of memory addresses associated with the reference frame based on the determined set of RTW by deallocating the set of memory addresses after the last time window of the determined set of RTW. The apparatus may further include means for refraining from allocating a second set of memory addresses to a second subset of the set of frames based on an identification of the second subset of the set of frames as a set of unreferenced frames. The apparatus may further include means for determining the set of RTW for each reference frame of the identified set of reference frames by determining a first set of contiguous RTW and a second set of contiguous RTW associated with the reference frame. The second set of contiguous RTW may be after the first set of contiguous RTW. A time gap may exist between the first set of contiguous RTW and the second set of contiguous RTW. The set of memory addresses may be associated with a first memory storage device. The apparatus may further include means for processing a subset of the set of frames during the first set of contiguous RTW. The apparatus may further include means for storing the reference frame in a second set of memory addresses associated with a second memory storage device different from the first memory storage device in response to the time gap being less than a threshold time period. The apparatus may further include means for deallocating the set of memory addresses associated with the reference frame based on the determined set of RTW by deallocating the set of memory addresses after a last frame of the first set of contiguous RTW. The first memory storage device may include memory. The second memory storage device may include a hard disk memory. The apparatus may further include means for reading the reference frame from the second set of memory addresses associated with the second memory storage device. The apparatus may further include means for storing the reference frame in a third set of memory addresses associated with the first memory storage device based on the second set of contiguous RTW. The apparatus may further include means for processing a second subset of the set of frames during the second set of contiguous RTW. The apparatus may further include means for deallocating the third set of memory addresses based on the second set of contiguous RTW. The apparatus may further include means for deallocating the second set of memory addresses associated with the reference frame based on the determined set of RTW. The apparatus may further include means for determining a first time period for storing the reference frame in the second set of memory addresses associated with the second memory storage device. The apparatus may further include means for determining a second time period for storing the reference frame in the third set of memory addresses associated with the first memory storage device. The apparatus may further include means for determining the threshold time period as a sum of the first time period and the second time period. The apparatus may further include means for decoding a second set of frames. The apparatus may further include means for identifying a second subset of the second set of frames as a second set of reference frames. The apparatus may further include means for determining the set of RTW for the reference frame of the identified set of reference frames by (a) determining a second set of RTW for a second reference frame of the identified second set of reference frames, (b) correlating the second reference frame of the identified second set of reference frames with the reference frame of the identified set of reference frames, and (c) determining the set of RTW based on the correlated second reference frame and the determined second set of RTW. The apparatus may further include means for deallocating a set of preallocated memory addresses associated with a third subset of the set of frames based on an identification of the third subset of the set of frames as a set of unreferenced frames. The apparatus may further include means for decoding a second set of frames. The apparatus may further include means for identifying a second subset of the second set of frames as a second set of reference frames. The apparatus may further include means for decoding a third set of frames; and identifying a third subset of the third set of frames as a third set of reference frames. The apparatus may further include means for determining the set of RTW for the reference frame of the identified set of reference frames by (1) determining a second set of RTW for a second reference frame of the identified second set of reference frames, (2) determining a third set of RTW for a third reference frame of the identified third set of reference frames, (3) identifying a correlation between the second reference frame of the identified second set of reference frames and the reference frame of the identified set of reference frames or between the third reference frame of the identified third set of reference frames and the reference frame of the identified set of reference frames, and (4) determining the set of RTW based on (a) the correlated second reference frame and the determined second set of RTW or (b) the correlated third reference frame and the determined third set of RTW. The means may include the frame allocation engine 198 in FIG. 1.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, comprising: obtaining an indication of a set of frames for processing; identifying a subset of the set of frames as a set of reference frames; determining a set of reference timing windows (RTW) for a reference frame of the identified set of reference frames; and deallocating a set of memory addresses associated with the reference frame based on the determined set of RTW.

Aspect 2 is the method of aspect 1, further comprising: processing the set of frames in response to the obtained indication of the set of frames for processing, wherein processing the set of frames comprises encoding the set of frames; and outputting an indication of the encoded set of frames.

Aspect 3 is the method of either of aspects 1 or 2, further comprising: processing the set of frames in response to the obtained indication of the set of frames for processing, wherein processing the set of frames comprises decoding the set of frames; and outputting an indication of the decoded set of frames.

Aspect 4 is the method of any of aspects 1 to 3, further comprising: storing the reference frame in the set of memory addresses based on the determined set of RTW.

Aspect 5 is the method of any of aspects 1 to 4, further comprising: encoding a subset of the set of frames during a last time window of the determined set of RTW, wherein deallocating the set of memory addresses associated with the reference frame based on the determined set of RTW comprises: deallocating the set of memory addresses after the last time window of the determined set of RTW.

Aspect 6 is the method of any of aspects 1 to 5, further comprising: refraining from allocating a second set of memory addresses to a second subset of the set of frames based on an identification of the second subset of the set of frames as a set of unreferenced frames.

Aspect 7 is the method of any of aspects 1 to 6, wherein determining the set of RTW for each reference frame of the identified set of reference frames comprises: determining a first set of contiguous RTW and a second set of contiguous RTW associated with the reference frame, wherein the second set of contiguous RTW is after the first set of contiguous RTW, wherein a time gap exists between the first set of contiguous RTW and the second set of contiguous RTW, wherein the set of memory addresses are associated with a first memory storage device, further comprising: processing a subset of the set of frames during the first set of contiguous RTW; and storing the reference frame in a second set of memory addresses associated with a second memory storage device different from the first memory storage device in response to the time gap being less than a threshold time period, wherein deallocating the set of memory addresses associated with the reference frame based on the determined set of RTW comprises: deallocating the set of memory addresses after a last frame of the first set of contiguous RTW.

Aspect 8 is the method of aspect 7, wherein the first memory storage device comprises double data rate (DDR) memory and the second memory storage device comprises a hard disk memory.

Aspect 9 is the method of either of aspects 7 or 8, further comprising: reading the reference frame from the second set of memory addresses associated with the second memory storage device; storing the reference frame in a third set of memory addresses associated with the first memory storage device based on the second set of contiguous RTW; processing a second subset of the set of frames during the second set of contiguous RTW; and deallocating the third set of memory addresses based on the second set of contiguous RTW.

Aspect 10 is the method of aspect 9, further comprising: deallocating the second set of memory addresses associated with the reference frame based on the determined set of RTW.

Aspect 11 is the method of either of aspects 9 or 10, further comprising: determining a first time period for storing the reference frame in the second set of memory addresses associated with the second memory storage device; determining a second time period for storing the reference frame in the third set of memory addresses associated with the first memory storage device; and determining the threshold time period as a sum of the first time period and the second time period.

Aspect 12 is the method of any of aspects 1 to 11, further comprising: decoding a second set of frames; and identifying a second subset of the second set of frames as a second set of reference frames, wherein determining the set of RTW for the reference frame of the identified set of reference frames comprises: determining a second set of RTW for a second reference frame of the identified second set of reference frames; correlating the second reference frame of the identified second set of reference frames with the reference frame of the identified set of reference frames; and determining the set of RTW based on the correlated second reference frame and the determined second set of RTW.

Aspect 13 is the method of aspect 12, further comprising: deallocating a set of preallocated memory addresses associated with a third subset of the set of frames based on an identification of the third subset of the set of frames as a set of unreferenced frames.

Aspect 14 is the method of any of aspects 1 to 13, further comprising: decoding a second set of frames; identifying a second subset of the second set of frames as a second set of reference frames; decoding a third set of frames; and identifying a third subset of the third set of frames as a third set of reference frames, wherein determining the set of RTW for the reference frame of the identified set of reference frames comprises: determining a second set of RTW for a second reference frame of the identified second set of reference frames; determining a third set of RTW for a third reference frame of the identified third set of reference frames; identifying a correlation between the second reference frame of the identified second set of reference frames and the reference frame of the identified set of reference frames or between the third reference frame of the identified third set of reference frames and the reference frame of the identified set of reference frames; and determining the set of RTW based on (a) the correlated second reference frame and the determined second set of RTW or (b) the correlated third reference frame and the determined third set of RTW.

Aspect 15 is an apparatus for display processing including at least one processor coupled to a memory and configured to implement a method as in any of aspects 1-14.

Aspect 16 may be combined with aspect 15 and includes that the apparatus is a wireless communication device.

Aspect 17 is an apparatus for display processing including means for implementing a method as in any of aspects 1-14.

Aspect 18 is a computer-readable medium (e.g., a non-transitory computer-readable medium) storing computer executable code, the code when executed by at least one processor causes the at least one processor to implement a method as in any of aspects 1-14.

Various aspects have been described herein. These and other aspects are within the scope of the following claims.

1. An apparatus for display processing, comprising:
a memory; and
a processor coupled to the memory and, based at least in part on information stored in the memory, the processor is configured to:
obtain an indication of a set of frames for processing;
identify a subset of the set of frames as a set of reference frames;
determine a set of reference timing windows (RTW) for a reference frame of the identified set of reference frames, wherein each RTW of the set of RTWs indicates a time window during which one or more frames of the set of frames refer to the reference frame; and
deallocate a set of memory addresses associated with the reference frame based on the determined set of RTW.

2. The apparatus of claim 1, wherein the processor is further configured to:
process the set of frames in response to the obtained indication of the set of frames for processing, wherein, to process the set of frames, the processor is configured to encode the set of frames; and
output an indication of the encoded set of frames.

3. The apparatus of claim 1, wherein the processor is further configured to:
process the set of frames in response to the obtained indication of the set of frames for processing, wherein, to process the set of frames, the processor is configured to decode the set of frames; and
output an indication of the decoded set of frames.

4. The apparatus of claim 1, wherein the processor is further configured to:
store the reference frame in the set of memory addresses based on the determined set of RTW.

5. The apparatus of claim 1, wherein the processor is further configured to:
encode a subset of the set of frames during a last time window of the determined set of RTW, wherein, to deallocate the set of memory addresses associated with the reference frame based on the determined set of RTW, the processor is configured to:
deallocate the set of memory addresses after the last time window of the determined set of RTW.

6. The apparatus of claim 1, wherein the processor is further configured to:
refrain from allocating a second set of memory addresses to a second subset of the set of frames based on an identification of the second subset of the set of frames as a set of unreferenced frames.

7. The apparatus of claim 1, wherein, to determine the set of RTW for each reference frame of the identified set of reference frames, the processor is configured to:
determine a first set of contiguous RTW and a second set of contiguous RTW associated with the reference frame, wherein the second set of contiguous RTW is after the first set of contiguous RTW, wherein a time gap exists between the first set of contiguous RTW and the second set of contiguous RTW, wherein the set of memory addresses are associated with a first memory storage device, wherein the processor is further configured to:
process a subset of the set of frames during the first set of contiguous RTW; and
store the reference frame in a second set of memory addresses associated with a second memory storage device different from the first memory storage device in response to the time gap being less than a threshold time period, wherein, to deallocate the set of memory addresses associated with the reference frame based on the determined set of RTW, the processor is configured to:
deallocate the set of memory addresses after a last frame of the first set of contiguous RTW.

8. The apparatus of claim 7, wherein the first memory storage device comprises double data rate (DDR) memory and the second memory storage device comprises a hard disk memory.

9. The apparatus of claim 7, wherein the processor is further configured to:
read the reference frame from the second set of memory addresses associated with the second memory storage device;
store the reference frame in a third set of memory addresses associated with the first memory storage device based on the second set of contiguous RTW;
process a second subset of the set of frames during the second set of contiguous RTW; and
deallocate the third set of memory addresses based on the second set of contiguous RTW.

10. The apparatus of claim 9, wherein the processor is further configured to:
deallocate the second set of memory addresses associated with the reference frame based on the determined set of RTW.

11. The apparatus of claim 9, wherein the processor is further configured to:
determine a first time period for storing the reference frame in the second set of memory addresses associated with the second memory storage device;
determine a second time period for storing the reference frame in the third set of memory addresses associated with the first memory storage device; and
determine the threshold time period as a sum of the first time period and the second time period.

12. The apparatus of claim 1, wherein the processor is further configured to:
decode a second set of frames; and
identify a second subset of the second set of frames as a second set of reference frames, wherein, to determine the set of RTW for the reference frame of the identified set of reference frames, the processor is configured to:
determine a second set of RTW for a second reference frame of the identified second set of reference frames;
correlate the second reference frame of the identified second set of reference frames with the reference frame of the identified set of reference frames; and
determine the set of RTW based on the correlated second reference frame and the determined second set of RTW.

13. The apparatus of claim 12, wherein the processor is further configured to:
deallocate a set of preallocated memory addresses associated with a third subset of the set of frames based on an identification of the third subset of the set of frames as a set of unreferenced frames.

14. The apparatus of claim 1, wherein the processor is further configured to:
decode a second set of frames;
identify a second subset of the second set of frames as a second set of reference frames;
decode a third set of frames; and
identify a third subset of the third set of frames as a third set of reference frames, wherein, to determine the set of RTW for the reference frame of the identified set of reference frames, the processor is configured to:
determine a second set of RTW for a second reference frame of the identified second set of reference frames;
determine a third set of RTW for a third reference frame of the identified third set of reference frames;
identify a correlation between the second reference frame of the identified second set of reference frames and the reference frame of the identified set of reference frames or between the third reference frame of the identified third set of reference frames and the reference frame of the identified set of reference frames; and
determine the set of RTW based on (a) the correlated second reference frame and the determined second set of RTW or (b) the correlated third reference frame and the determined third set of RTW.

15. The apparatus of claim 1, wherein the apparatus comprises a wireless communication device.

16. A method of display processing, comprising:
obtaining an indication of a set of frames for processing;
identifying a subset of the set of frames as a set of reference frames;
determining a set of reference timing windows (RTW) for a reference frame of the identified set of reference frames, wherein each RTW of the set of RTWs indicates a time window during which one or more frames of the set of frames refer to the reference frame; and
deallocating a set of memory addresses associated with the reference frame based on the determined set of RTW.

17. The method of claim 16, further comprising:
refraining from allocating a second set of memory addresses to a second subset of the set of frames based on an identification of the second subset of the set of frames as a set of unreferenced frames.

18. The method of claim 16, wherein determining the set of RTW for each reference frame of the identified set of reference frames comprises:
determining a first set of contiguous RTW and a second set of contiguous RTW associated with the reference frame, wherein the second set of contiguous RTW is after the first set of contiguous RTW, wherein a time gap exists between the first set of contiguous RTW and the second set of contiguous RTW, wherein the set of memory addresses are associated with a first memory storage device, further comprising:
processing a subset of the set of frames during the first set of contiguous RTW; and
storing the reference frame in a second set of memory addresses associated with a second memory storage device different from the first memory storage device in response to the time gap being less than a threshold time period, wherein deallocating the set of memory addresses associated with the reference frame based on the determined set of RTW comprises:
deallocating the set of memory addresses after a last frame of the first set of contiguous RTW.

19. The method of claim 16, further comprising:
decoding a second set of frames; and
identifying a second subset of the second set of frames as a second set of reference frames, wherein determining the set of RTW for the reference frame of the identified set of reference frames comprises:
determining a second set of RTW for a second reference frame of the identified second set of reference frames;
correlating the second reference frame of the identified second set of reference frames with the reference frame of the identified set of reference frames; and
determining the set of RTW based on the correlated second reference frame and the determined second set of RTW.

20. A computer-readable medium storing computer executable code, the code when executed by a processor, causes the processor to:
obtain an indication of a set of frames for processing;
identify a subset of the set of frames as a set of reference frames;
determine a set of reference timing windows (RTW) for a reference frame of the identified set of reference frames, wherein each RTW of the set of RTWs indicates a time window during which one or more frames of the set of frames refer to the reference frame; and
deallocate a set of memory addresses associated with the reference frame based on the determined set of RTW.
